(19) United States
(12) Patent Application Publication
(10) Pub. No.: US 2023/0308047 A1
(43) Pub. Date: Sep. 28, 2023

(54) Expandable All-in-One Solar Generator

(71) Applicant: Tyler LeMay, St. Louis, MO (US)

(72) Inventor: Tyler LeMay, St. Louis, MO (US)

(21) Appl. No.: 17/200,794

(22) Filed: Mar. 13, 2021

Related U.S. Application Data
(60) Provisional application No. 62/989,055, filed on Mar. 13, 2020.

(51) Int. Cl. H02S 30/00; H02S 40/32; H02S 40/38; H02S 40/42

(52) U.S. Cl. CPC H02S 30/00; H02S 40/32; H02S 40/38; H02S 40/425

(57) ABSTRACT

An all-in-one solar panel-based generator case is disclosed. The case has a hinged lid having a solar panel. The contents of the case include multiple components. These components include a battery bank, a temperature controller for a vent fan, an electric vent fan unit for circulating air throughout the all-in-one solar panel-based generator case, a set of DC circuit breakers for DC accessory connectors, a lid charge controller, an auxiliary solar array charge controller, a power inverter, and a set of DC circuit breakers for solar power input.

### CROSS-REFERENCE TO RELATED APPLICATION

This application claims priority to United States Provisional Pat. pplication Number 62/989,055, titled ” XPANDABLE ALL-IN-ONE SOLAR PANEL GENERATOR,” and filed on Mar. 13, 2020. The entire application is incorporated herein by reference in its entirety.

### TECHNICAL FIELD

This application relates in general to an article of manufacture for providing an expandable all-in-one solar panel-based generator.

### SUMMARY

In accordance with the present invention, the above and other problems are solved by for providing an expandable all-in-one solar panel-based generator according to the principles and example embodiments disclosed herein.

In one embodiment, the present invention is a the solar generator case including a self-contained electronics case, a solar panel lid for enclosing an electronics cavity within the self-contained electronics case coupled to a side of the self-contained electronics case, a battery bank for storing electrical energy for use by the self-contained electronics case when used, a lid charge controller for connecting the solar panel to the battery bank, the lid charge controller controls and limits current and voltage from lid solar panel to battery bank, one or more power inverter having DC input voltages electrically coupling the battery bank, lid charge controller, and the solar panel lid to the power inverter to generate AC output voltages for use by attached devices, a DC voltage powered cooling fan coupled to an inside surface of the self-contained electronics case to draw air out of the electronics cavity, and a plurality of internal connections for providing voltage connections to the output voltages generated by the power inverter. The plurality of internal connections comprises DC voltage connectors, DC accessory voltage connectors, and input AC output voltage connectors. The DC voltage accessory connectors are electrically coupled to the battery bank and the AC output connectors electrically coupled to the output connections of the power converter. The lid having a lid solar panel to generate electrical energy for use by components within the self-contained electronics case.

In another aspect of the present disclosure, the all-in-one solar generator further comprises a rotary selector bypass switch for selecting an AC output voltage value to be provided by the power inverter as the AC output voltages, the AC output voltage is a 120/240 voltage.

In another aspect of the present disclosure, the all-in-one solar generator further includes an auxiliary charge controller for connecting an external solar array to the battery bank, the auxiliary charge controller controls and limits current and voltage from the external solar panel to battery bank, and an external solar panel connector electrically connecting the external solar array to the auxiliary charge controller.

In another aspect of the present disclosure, the all-in-one solar generator further includes a first DC current circuit breaker between the lid solar panel and the lid charge controller, a second DC current circuit breaker between the lid charge controller and the battery bank, and a set of third DC current circuit breakers between the battery bank and the DC accessory voltage connectors.

In another aspect of the present disclosure, the all-in-one solar generator further comprises AC voltage input connections to supply AC voltage from an external AC power source to the power inverter.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BACKGROUND

Solar power-based generators are becoming more prevalent as solar technology matures. Currently, however, these solar power-based generators are very small in scale, not expandable, not complete working systems, and do not work with grid or generator power. This fact makes the use of solar power-based generators not as effective and has slowed their adoption in all but a handful of possible situations. A need exists to broaden the usefulness and availability of these generators in an increasing number of uses and environment.

The present invention attempts to address deficiencies of the existing solar panel-based power generators according to the principles and example embodiments disclosed herein.

### BRIEF DESCRIPTION OF THE DRAWINGS

Referring now to the drawings in which like reference numbers represent corresponding parts throughout:

FIG. 1 illustrates one potential embodiment of an article of manufacture for providing an expandable all-in-one solar panel-based generator according to the present invention.

FIG. 2 illustrates a top panel for an article of manufacture for providing an expandable all-in-one solar panel-based generator according to the present invention.

FIG. 3 illustrates a top panel for an article of manufacture for providing an expandable all-in-one solar panel-based generator according to the present invention.

FIG. 4 illustrates a top panel for an article of manufacture for providing an expandable all-in-one solar panel-based generator according to the present invention.

FIGS. 5a-c illustrate a pair of side panels and dimensions for an article of manufacture for providing an expandable all-in-one solar panel-based generator according to the present invention.

FIGS. 6a-b illustrate a front and back panel and an inside view of an article of manufacture for providing an expandable all-in-one solar panel-based generator according to the present invention.

FIG. 7 illustrates an example circuit schematic an article of manufacture for providing an expandable all-in-one solar panel-based generator according to the present invention.

### DETAILED DESCRIPTION

This application relates in general to an article of manufacture for providing an expandable all-in-one solar panel-based generator according to the present invention.

Various embodiments of the present invention will be described in detail with reference to the accompanying drawings, wherein like reference numerals represent like parts and assemblies throughout the several views. Reference to various embodiments does not limit the scope of the invention, which is limited only by the scope of the claims attached hereto. Additionally, any examples set forth in this application are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

As error and the like, and other factors known to those of skill. Further, unless otherwise stated, the term “about” shall expressly include “exactly,” consistent with the discussion above regarding ranges and numerical data.

The term “user” and “technician” refers to an entity, e.g. a human, that operates a device according to the present invention in order to bring about a desired effect or outcome, particularly provide the user an ability to generate solar power. In a particular case, the user is one that utilizes an article of manufacture for providing an expandable all-in-one solar panel-based generator according to the present invention. For such a user, the terms “user” and “technician” may be used interchangeably herein.

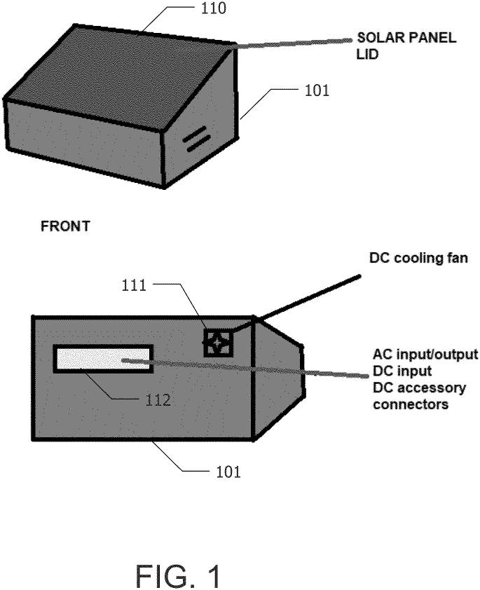

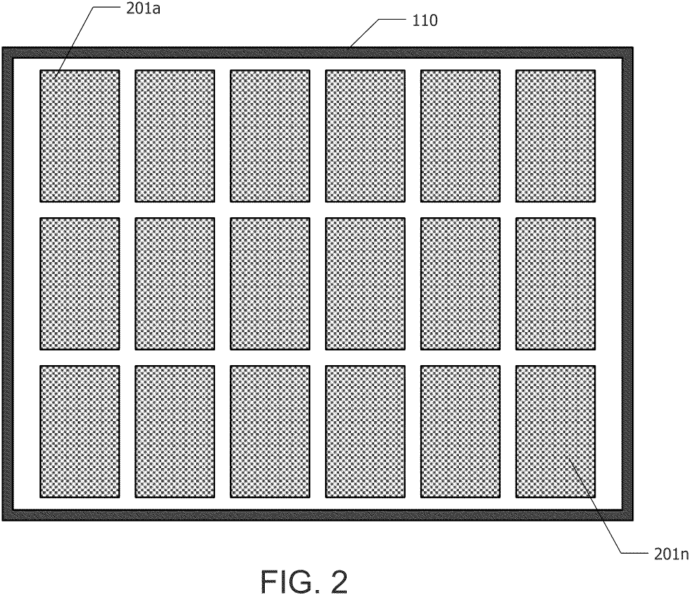

In general, the present disclosure relates an article of manufacture for providing an expandable all-in-one solar panel-based generator according to the present invention. To better understand the present invention, FIG. 1 illustrates one potential embodiment of an article of manufacture for providing an expandable all-in-one solar panel-based generator according to the present invention.

The all-in-one solar panel-based generator case 101 incorporates a solar panel 110 into the lid, thereby eliminating the need for extra permits and for placing and taking down panels when in use. The all-in-one solar panel-based generator case 101 includes DC accessory connections 112 for adding on items like automated lighting, a solar water heater, and other items. The all-in-one solar panel-based generator case 101 also includes a built-in charge controller for the solar panel 110 and an additional charge controller for an auxiliary solar panel array. This all-in-one solar panel-based generator case 101 design provides a way to have in one place all of the necessary components for a complete off-grid or grid tied solar panel system for back-up power energy savings and for providing power where there is no grid power available. DC connectors 112 provide a way to run items more energy efficiently and, by not running through the inverter allows items to run if the inverter fails.

The all-in-one solar panel-based generator case 101 design allows for easy expansion as well allows the system to be built to fit most budgets and output needs. When operating, this all-in-one solar panel-based generator 101 can be a stand-alone power supply that connects to an outside power supply, such as a grid or a generator, to supplement and charge an internal battery bank. When set up where power is available, the all-in-one solar panel-based generator 101 can operate as emergency back-up power and can operate chosen circuits when there is enough power from its batteries, its solar panels, or when grid power is down or a grid tied system.

The all-in-one solar panel-based generator case 101 may also include AC input/output connectors, a DC input, and DC accessory connectors 112. A DC cooling fan 111 may be included as needed to ensure safe and continued operation in a multitude of environments.

FIG. 2 illustrates a top panel for an article of manufacture for providing an expandable all-in-one solar panel-based generator with its lid closed according to the present invention. The top panel 110 of the all-in-one solar panel-based generator case 101 consists of a plurality of solar cells. These solar cells generate electrical power in the form of voltages and currents from solar energy falling upon the solar arrays 110 The solar panel generates between 270-300+ watts depending on the particular solar panels that are available. Manufactures of the panels often release an updated panel about twice a year in which output goes up but dimensions typically are the same. Moving the system 100 is accomplished by simply picking it up. The system 100 requires a base such as block or concrete platform where it is set down keeping it sitting level and from sinking into the ground.

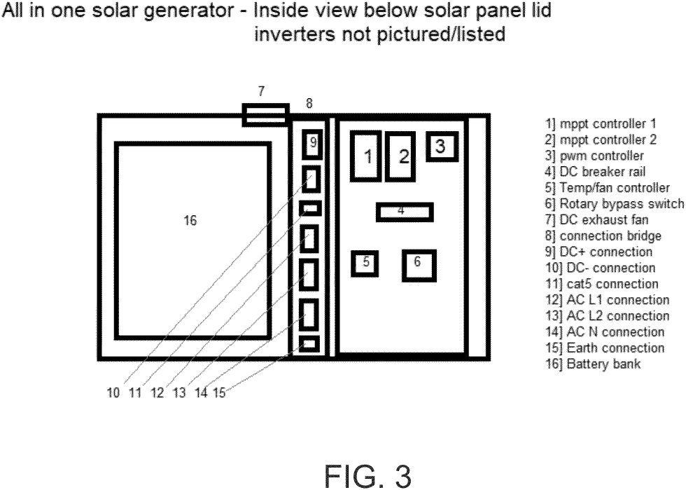

FIG. 3 illustrates a top panel for an article of manufacture for providing an expandable all-in-one solar panel-based generator with its lid open according to the present invention.. The case comprises a battery bank 16 on a left side of the inside of the case 101. In a center connection bridge 8, a number of components are positioned including a DC+ voltage connection 9, a DC- voltage connection 10, a cat5 connection 11, an AC voltage L1 connection 12, an AC voltage L2 connection 13, an AC voltage neutral connection 14, and an earth ground connection 15. Each of these connections provide an electrical connector to permit access to these various connections.

The DC+ voltage connection 9 is a main connector for DC+, uses screw down clamp connector. The DC- voltage connection 10 is a main connector for DC-, uses screw down clamp connector. The cat5 connection 11 uses a cat5 connector for internet, remote, and accessory communication. The AC voltage L1 connection 12 is a screw down clamp connector for connecting AC L1 input/output. The AC voltage L2 connection 13 is a screw down clamp connector for connecting AC L1 input/output. The AC voltage Neutral connection 14 - screw down clamp connector for AC neutral input/output. The Earth ground connection 15 - screw down clamp connector for connecting ground.

On the right side of the all-in-one solar panel-based generator case 101 are a number of components including a mppt controller 11, a mppt controller 2 2, a pwm controller 3, a DC breaker rail 4, a temperature/fan controller 5 a rotary bypass switch 6, and a DC voltage powered exhaust fan 7.

The mppt controller 11 corresponds to an auxiliary solar array charge controller. The mppt controller 22 corresponds to an auxiliary solar array charge controller. The pwm controller 3 corresponds to a lid solar charge controller. The DC breaker rail 4 provides DC circuit breakers for charge controllers and DC accessories using screw down clamps. The temperature/fan controller 5 is a programmable temperature relay to turn exhaust fan on/off. The rotary bypass switch 6 provides a bypasses inverter in case of failure to keep connected circuits powered. The DC voltage powered exhaust fan 7 provides an exhaust fail used to keep temperature down inside case,

Current accessories could be the DC hot water heater (20 amps), DC lighting, DC pumps (fountain, sump, etc.), and gate motors. Each of these accessories have many different options, any DC circuit breakers used with any accessories are sized by their respective manufacturer or tested running load current. The battery bank 302 is 24 volts, minimum of 90 amp hour @ 24 VDC, and may be expanded at any time, including before installation or any time later.

A right side of the all-in-one solar panel-based generator case 301 includes a lid charge controller 303, an auxiliary solar array charge controller 304, a set of DC circuit breakers 309a-c for solar power input, and a manual service bypass switch 702. Lid charge controller 303 is typically a 10 amp 24 volt charge controller that controls and limits current and voltage from lid solar panel 110 to battery bank 302. The manual service bypass switch 702 is a rotary changeover switch that is typically rated for 63 amps.

Auxiliary charge controller 304 may be sized to accommodate associated solar array size, typically at least 60 amp rated charge controller. This controller 304 controls and limits amperage and voltage from solar array to battery bank. Any circuit breaker value sized for both charge controllers may be used. One example DC breaker used for these charge controllers 303-304 may be a Schneider Electric DC miniature circuit breaker model no. D65H-DC-2P.

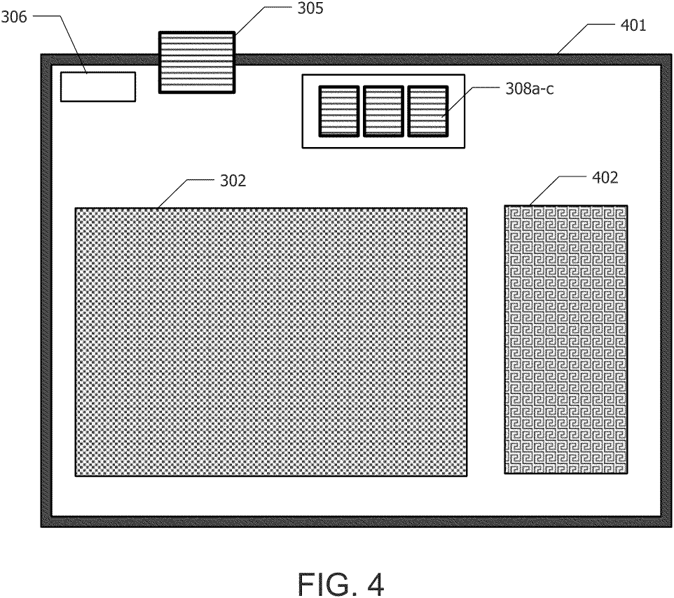

FIG. 4 illustrates a top panel for an article of manufacture for providing an expandable all-in-one solar panel-based generator having its lid open and having its charge controllers removed according to the present invention. The all-in-one solar panel-based generator case 401 is shown after the panel containing two charge controllers 303-304 have been removed. A power inverter 402 is located underneath these charge controllers.

The power inverter 402 is typically sized based upon customer needs. The power inverter 402 input power will be 24 volts DC and 120/240 volt AC. If the power inverter 402 is set to back up only mode, the power inverter will act as a pass through for the 120/240 volt AC coming from grid power whenever present. If grid power goes down or is removed, the power inverter 402 draw from solar/batteries to generator 120/240 volt AC power. If grid power is reconnected, the power inverter 402 tests incoming power, and if acceptable, switch back to be a pass through for grid power. If the power inverter 402 is set up to possess a solar/battery priority, the power inverter generates output power using solar/battery until the battery bank is drained to a predetermined amount of discharge. The power inverter automatically switches to using grid power until the battery bank is fully charged or when grid power is removed. When set to grid tied mode, extra power may be fed back to the local electric grid. The remaining components shown in FIG. 4 are identical to the components described in FIG. 3 above.

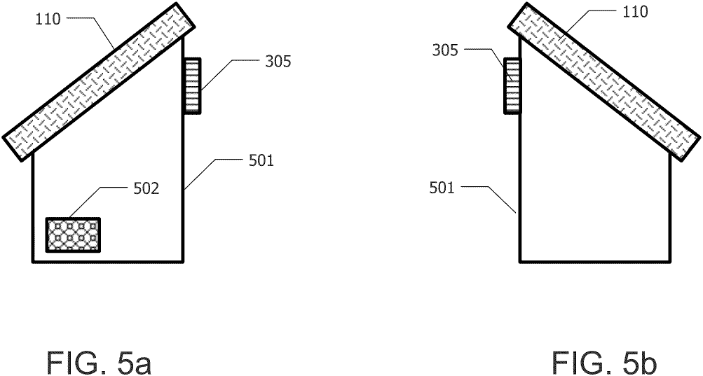

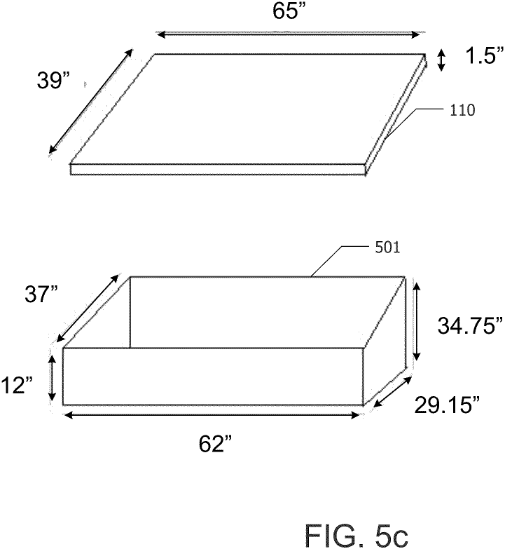

FIGS. 5a-c illustrate a pair of side panels and dimensions for an article of manufacture for providing an expandable all-in-one solar panel-based generator according to the present invention. The left side view of the all-in-one solar panel-based generator case 501 shows the solar array lid 110, a cooling input vent 502, and the electric vent fan unit 305 on the back side of the unit. The right side view of the all-in-one solar panel-based generator case 501 shows the solar array lid 110 and the electric vent fan unit 305 on the back side of the unit. The dimensions for one example embodiment of all-in-one solar panel-based generator case 501 in FIG. 5c.

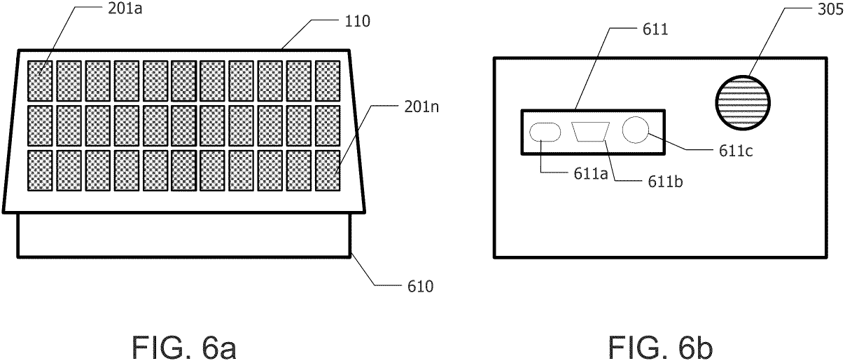

FIGS. 6a-b illustrate a front and back panel and an inside view of an article of manufacture for providing an expandable all-in-one solar panel-based generator according to the present invention. The front view of FIG. 6a shows the solar array lid 110 and a base of the case 610. The solar array lid 110 is hinged along the top edge and is covered by a set of solar cells. The rear view of the case 610 includes a set of connectors 611 and the electric vent fan unit 305. The power inverter 402 also has built in circuit breakers as well that are also sized relative to output wattage. The DC connections are all mechanical, having circuit breakers screw down clamps on batteries ring terminals which are fastened with nuts on studs. Ring terminals are crimp connections onto battery cables. Cables are sized based upon the power inverter 402 output wattage.

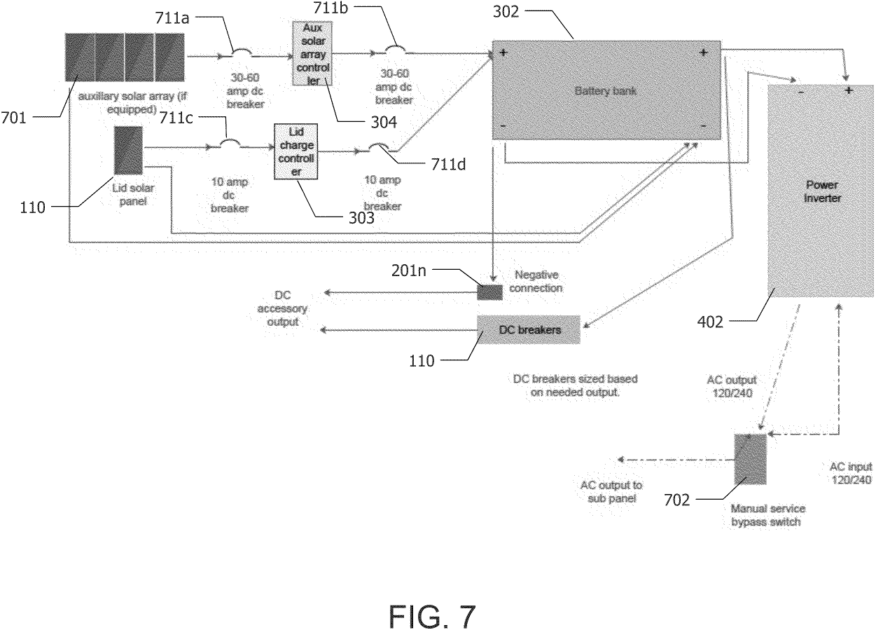

FIG. 7 illustrates an example circuit schematic an article of manufacture for providing an expandable all-in-one solar panel-based generator 100 according to the present invention. The lid solar panel 110 is connected to the lid charge controller 303 which is in turn connected to battery bank 302. The battery bank 302 is connected to power inverter 402 that generates an AC output voltage. This AC output voltage is output by the all-in-one solar panel-based generator 100 directly or through a manual service bypass switch 702.

An external auxiliary solar panel array 702 is connected to the auxiliary power controller 304 that is in turn connected to the battery bank 302 in parallel to the lid solar panel 110. All of the connections between the solar panels 110, 701 and power controllers 303-304 via various DC circuit breakers 711a-d in which these circuit breakers are typically 30-60 amp breakers.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. An all-in-one solar generator for providing an expandable all-in-one solar panel-based voltage generator, the voltage generator case comprises:
a self-contained electronics case;
a solar power lid for enclosing an electronics cavity within the self-contained electronics case coupled to a side of the self-contained electronics case, the lid having a lid solar panel to generate electrical energy for use by components within the self-contained electronics case;
a battery bank for storing electrical energy for use by the self-contained electronics case when used;
a lid charge controller for connecting the solar panel to the battery bank, the lid charge controller controls and limits current and voltage from lid solar panel to battery bank;
a power inverter having DC input voltages electrically coupling the battery bank, lid charge controller, and the solar panel lid to the power inverter to generate AC output voltages for use by attached devices;
a DC voltage powered cooling fan coupled to an inside surface of the self-contained electronics case to draw air out of the electronics cavity; and
a plurality of internal connections for providing voltage connections to the output voltages generated by the power inverter, the plurality of internal connections comprises DC voltage connectors, DC accessory voltage connectors, and AC output voltage connectors, the DC voltage accessory connectors are electrically coupled to the battery bank and the AC output connectors electrically coupled to the output connections of the power converter.

2. The all-in-one solar generator according to claim 1, wherein the all-in-one solar generator further comprises a rotary bypass selector for selecting an AC output voltage value to be provided by the power inverter as the AC output voltages, the AC output voltage is a 120/240 voltage.

3. The all-in-one solar generator according to claim 1, wherein the all-in-one solar generator further comprises:
an auxiliary charge controller for connecting an external solar array to the battery bank, the auxiliary charge controller controls and limits current and voltage from the external solar array to battery bank;
an internal solar panel connector electrically connecting the external solar array to the auxiliary charge controller.

4. The all-in-one solar generator according to claim 3, wherein the all-in-one solar generator further comprises:
a first DC current circuit breaker between the lid solar panel and the lid charge controller;
a second DC current circuit breaker between the lid charge controller and the battery bank; and
a set of third DC current circuit breakers between the battery bank and the DC accessory voltage connectors.

5. The all-in-one solar generator according to claim 4, wherein the all-in-one solar generator further comprises AC voltage input connections to supply AC voltage from an external AC power source to the power inverter.
